(19) United States
(12) Patent Application Publication
(10) Pub. No.: US 2009/0081966 A1
(43) Pub. Date: Mar. 26, 2009

(54) Communications device for remotely controlling an electrical device and method of manufacturing same

(75) Inventors: Thorben Neu, Los Angeles, CA (US); David Kleeman, Marina Del Rey, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 11/904,130

(22) Filed: Sep. 25, 2007

(51) Int. Cl. H04B 1/034

(52) U.S. Cl. 455/100

(57) ABSTRACT

A communications device (100) for remotely controlling an electrical device (690) can include: (a) a transmitter (220) for transmitting electrical signals; (b) a casing (110) having a first surface (129) in a first plane, and mechanically coupled to the transmitter; and (c) a user control mechanism (160) with an outer surface (161) and electrically coupled to the transmitter with the outer surface of the user control mechanism projecting out of the first plane. The casing and the transmitter are configured to be coupled to an upper arm of a user. The user control mechanism and the casing are flexible.

### FIELD OF THE INVENTION

This invention relates generally to electrical devices, and relates more particularly to communications devices for remotely controlling other electrical devices and methods of manufacturing the same.

### BACKGROUND OF THE INVENTION

Many skiers, snowboarders, and other winter sports enthusiasts enjoy using media players or other electrical devices while engaging in outdoor winter activities. Controlling media players or other electrical devices, however, can be difficult when a person is dressed for outdoor winter activities. Additionally, these electrical devices are usually placed under coats or other clothing to protect the electrical devices if the user falls, but this positioning makes controlling the electrical devices cumbersome because a user has to remove his gloves and open his coat to change any of the settings on the electrical device. Moreover, boaters, climbers, bikers, and the like can have similar problems because the media players or electrical devices usually have to be placed somewhere safe while these people engage in these activities.

Accordingly, a need exists for a control mechanism for an electrical device that is hard to damage and allows a user to control easily the electrical device when the electrical device is placed and/or protected at another location.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates a front, top, side isometric view of first and second portions of a communications device, according to a first embodiment;

FIG. 2 illustrates an exploded view of the first portion of the communications device of FIG. 1;

FIG. 3 illustrates a top, front, side isometric view of the first portion of the communications device of FIG. 1 coupled to a different second portion;

FIG. 4 illustrates a bottom view of the first portion of the communications device of FIG. 1;

FIG. 5 illustrates a top, front, side isometric view of the second portion of the communications device of FIG. 1;

FIG. 6 illustrates a top, front, side isometric view of a receiver coupled to an digital music player, according to the first embodiment;

FIG. 7 illustrates a front, top, side isometric view of the communications device of FIG. 1 coupled to an arm of a user; and

FIG. 8 illustrates a flow chart for an embodiment of a method of manufacturing a communications device.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a casing being coupled to an armband does not mean that the casing cannot be removed (readily or otherwise) from, or that it is permanently connected to, the armband.

### DETAILED DESCRIPTION OF EXAMPLES OF EMBODIMENTS

A number of embodiments provide a communications device for remotely controlling an electrical device. In these embodiments, the communications device can include: (a) a transmitter for transmitting electrical signals; (b) a casing having a first surface in a first plane with the casing mechanically coupled to the transmitter; and (c) a user control mechanism with an outer surface and electrically coupled to the transmitter with the outer surface of the user control mechanism projecting out of the first plane. The casing and the transmitter are configured to be coupled to an upper arm of a user. Furthermore, the user control mechanism and the casing are flexible.

Further embodiments provide an electrical device for transmitting data to an electrical receiver. In these embodiments, the electrical device can include: (a) a cover having a first surface; (b) a transmitting module located adjacent to the case and configured to broadcast the data; (c) at least four buttons extending beyond the first surface of the cover, electrically coupled to the transmitting module, and enclosed in the cover; (d) a first attachment mechanism configured to be coupled to a carabineer; and (e) a second attachment mechanism configured to be coupled to an armband. The at least four buttons are configured to instruct the transmitting module on the data to transmit. The at least four buttons collectively form an X-shape. Moreover, the at least four buttons, the first attachment mechanism, the second attachment mechanism, and the cover are flexible.

Yet other embodiments provide a method of manufacturing a communications device configured to remotely control an electrical device. The method can include: (a) providing a transmitter; (b) providing a casing having a surface in a first plane; (c) providing a flexible user control mechanism with an outer surface, and with the outer surface of the user control mechanism projecting out of the first plane; (d) electrically coupling the user control mechanism to the transmitter; and (e) enclosing the user control mechanism in the casing.

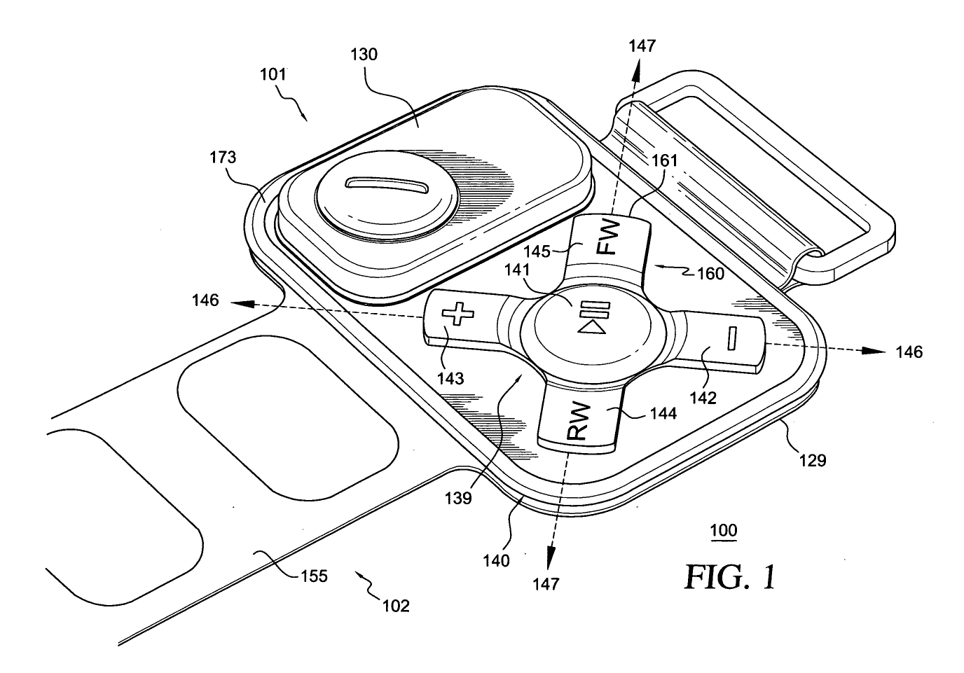

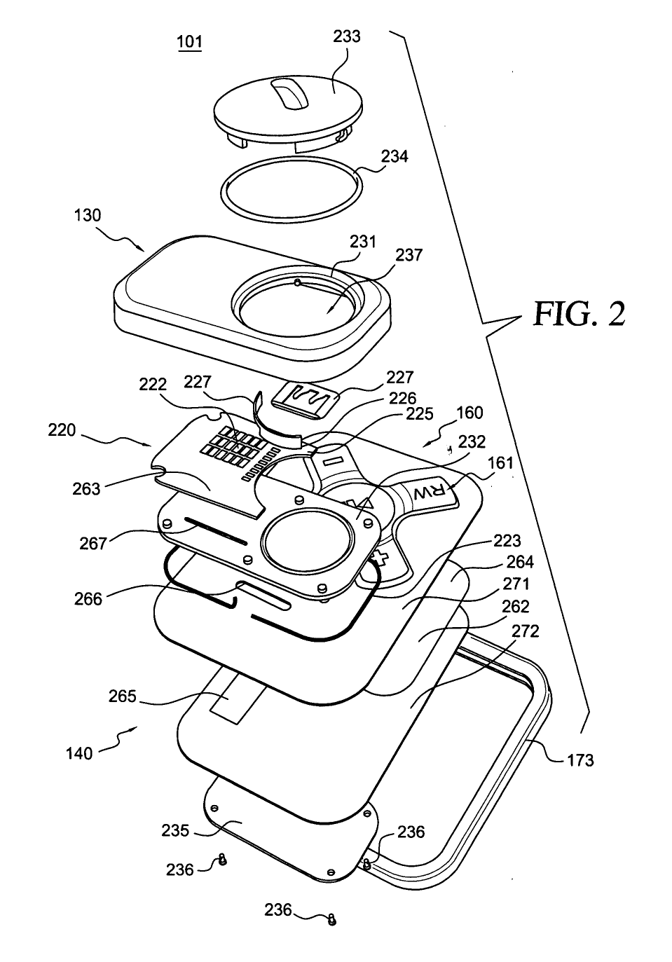

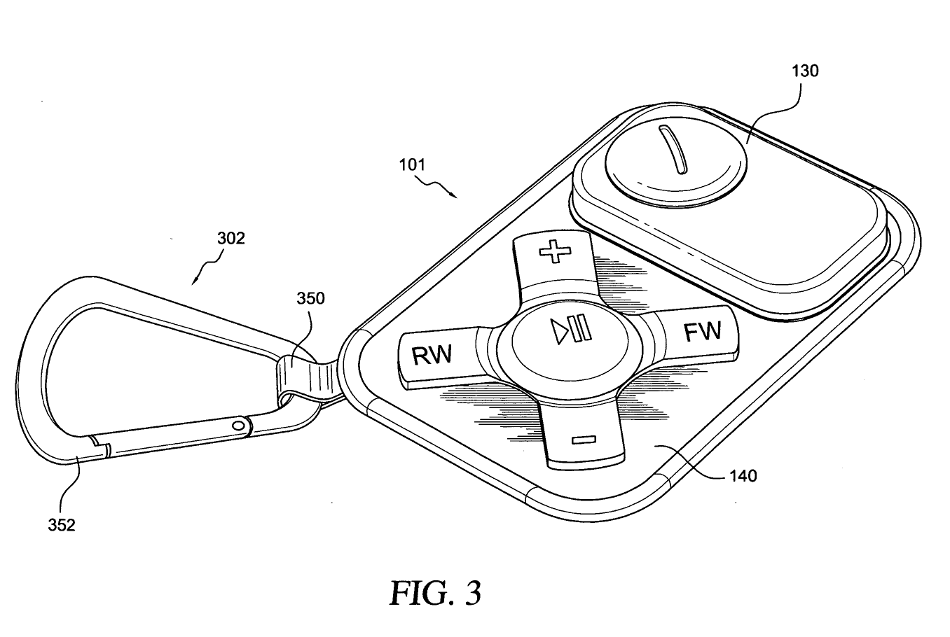

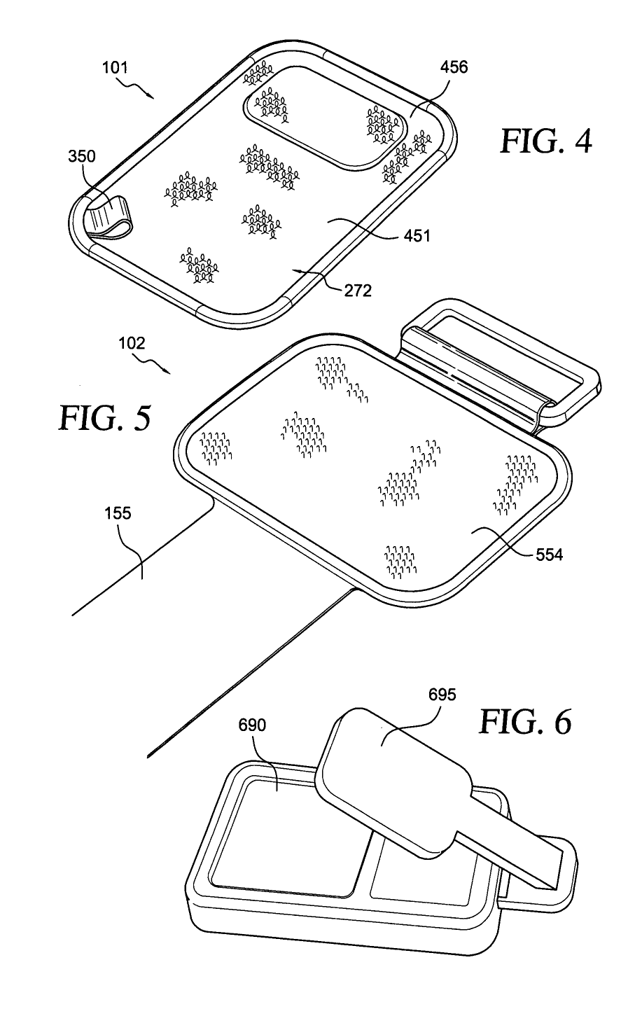

Turning to the drawings, FIG. 1 illustrates a front, top, side isometric view of a first portion 101 and a second portion 102 of a communications device 100, according to a first embodiment. FIG. 2 illustrates an exploded view of first portion 101 of communications device 100. FIG. 3 illustrates a top, front, side isometric view of first portion 101 of the communications device 100 coupled to a different second portion 302, namely, a carabineer 352. FIG. 4 illustrates a bottom view of first portion 101 of communications device 100. FIG. 5 illustrates a top, front, side isometric view of second portion 102 of communications device 100, namely, an armband 155.

Communications device 100 is merely exemplary and is not limited to the embodiments presented herein. Communications device 100 can be employed in many different embodiments or examples not specifically depicted or described herein.

In some embodiments, as illustrated in FIGS. 1-5, an electrical device or communications device 100 for remotely controlling another electrical device 690 (FIG. 6) can include: (a) a transmitter 220 for transmitting electrical signals; (b) a structure 130 for holding transmitter 220 and a portable power source (non-shown) removably coupled to transmitter 220; (c) a cover or casing 140 having a surface 129 in a first plane and mechanically coupled to transmitter 220; (d) a user control mechanism 160 with an outer surface 161 and electrically coupled to transmitter 220; (e) a coupling mechanism 350 configured to be coupled to a carabineer 352; (f) an armband 155 removably coupled to casing 140 and transmitter 220; (g) a coupling mechanism 451 configured to be coupled to armband 155. In the same or different examples, at least a portion of user control mechanism 160 and casing 140 are flexible. The flexibility of user control mechanism 160 and casing 140 allows a user to fall on communications device 100 without damaging communications device 100 or injuring himself. Furthermore, communications device 100 allows a user to simultaneously protect and operate electrical device 690 (FIG. 6) without removing gloves, coats or any other article of clothing.

In some embodiments, transmitter 220 is configured to broadcast data to a receiver 695 (FIG. 6). FIG. 6 illustrates a top, front, side isometric view of receiver 695 coupled to electrical device 690. Receiver 695 is configured to be removably coupled to electrical device 690. In some embodiments, the communication between transmitter 220 (FIG. 2) and receiver 695 is one-way, i.e., from transmitter 220 (FIG. 2) to receiver 695. In alternative embodiments, the communication is bi-directional. That is, transmitter 220 (FIG. 2) can send electrical signals to receiver 695 and receive electrical signals from receiver 695. Likewise, receiver 695 can send electrical signals to transmitter 220 (FIG. 2) and receive electrical signals from transmitter 220 (FIG. 2). In some embodiments, receiver 695 is not part of communications device 100 (FIG. 1). In alternative embodiments, receiver 695 is part of communications device 100 (FIG. 1).

In one example, electrical device 690 is a media player. For example, electrical device 690 can be an MP3 (MPEG-1 (Moving Picture Experts Group) Audio Layer 3) player. One MP3 player in widespread use is sold under the trademark iPod by Apple Computer, Inc. of Cupertino, Calif. In other examples, electrical device 690 can be other portable electrical devices.

In the illustrated example, transmitter 220 (FIG. 2) can communicate commands to receiver 695 for using electrical device 690. For example, transmitter 220 (FIG. 2) can transmit play, stop, next track, previous track, volume up, or volume down commands to receiver 695. Receiver 695 is configured to communicate the commands to electrical device 690.

Referring again to FIG. 2, transmitter 220 can include: (a) a transmission module 222 adjacent to or formed on circuit board 225; and (b) an antenna 223 coupled to transmission module 222.

In some embodiments, transmitter 220 broadcasts electrical signals through antenna 223 in the RF (radio frequency) spectrum. The RF spectrum is often considered to run from about 10 kHz (kilohertz) or below to about 100 GHz (gigahertz) or above, and transmitter 220 can utilize any appropriate frequency and/or any type of RF transmitter, including an AM (amplitude modulation) transmitter, an FM (frequency modulation) transmitter, a Bluetooth transmitter, or any other type of suitable RF transmitter. In another embodiment, transmitter 220 can broadcast electrical signals outside the RF spectrum.

Electrical power can be provided to transmitter 220 by a portable power source (not shown). The portable power source can be electrically coupled to transmitter 220 by a power unit 226. Power unit 226 can include contacts 227 that are coupled to or touching the portable power source. Power unit 226 can receive electrical power from the portable power source and provide the power to transmitter 220 and user control mechanism 160. In many examples, the portable power source is a battery.

Transmitter 220, power unit 226, and the portable power source can be at least partially enclosed by structure 130. In many embodiments, transmitter 220, power unit 226, and/or structure 130 are devoid of being covered by casing 140 (FIG. 1).

In various examples, as illustrated in FIG. 2, structure 130 can include: (a) an upper housing 231 with an aperture 237; (b) a lower housing 232; (c) a door 233; (d) a gasket 234; (e) a housing mount 235; and (f) screws 236. In some examples, upper housing 231 is coupled to lower housing 232 to permanently enclose transmitter 220 and power unit 226, and removably enclose the portable power source. The portable power source can be placed inside structure 130 through aperture 237. After the portable power source is placed inside of structure 130, door 233 can be placed inside of aperture 237 and securely fastened to structure 130 to hold the portable power source inside structure 130. In some examples, gasket 234 can be used to help securely fasten door 233 into aperture 237.

Housing mount 235 can be coupled to lower housing 232 to couple structure 130 to casing 140. In some examples, antenna 223 can be placed between lower housing 232 and an upper section 271 of casing 140. In the same or different embodiments, housing mount 235 is coupled to lower housing 232 using screws 236.

In a different embodiment, casing 140 can have an aperture (not shown) with structure 130 and transmitter 220 adjacent to the aperture. In this different embodiment, housing mount 235 could be unnecessary because structure 130 and casing 140 could be coupled together using other methods (e.g., an adhesive or screws).

Casing 140 can include: (a) upper section 271; (b) a bottom section 272 coupled to upper section 271; and (c) an edge portion 173. In some examples, at least a portion of user control mechanism 160 can be enclosed between upper section 271 and bottom section 272. In the same or different examples, edge portion 173 can be used to provide a smooth and aesthetically pleasing end or edge for communications device 100. In some embodiments, bottom section 272 is sewn to upper section 271, and/or bottom section 272 and upper section 271 are coupled together using an adhesive.

In some embodiments, user control mechanism 160 can include: (a) outer surface 161; (b) a sensing mechanism 262. Sensing mechanism 262 can be coupled to an interface circuit 263. Interface circuit 263 can communicate the instruction from user control mechanism 160 to transmitter 220. In various examples, interface circuit 263 is adjacent to or formed on circuit board 225.

In some examples, outer surface 161 can be contiguous with, adjacent to, or part of casing 140. In one embodiment, casing 140 includes an outer surface 161 of user control mechanism 160. That is, outer surface 161 and upper section 271 can be composed of a single material. For example, outer surface 161 and upper section 271 can be an ethylene-vinyl acetate (EVA) layer, with outer surface 161 being a molded portion of the EVA layer. In some examples, outer surface 161 projects out of the first plane. The first plane can be co-planar with at least a portion of upper section 271.

Sensing mechanism 262 can include: (a) a portion 264 adjacent to upper surface 161 and located between upper section 271 and bottom section 272; and (b) a portion 265 coupled to interface circuit 263. In some examples, portions 264 and 265 are the portions of user control mechanism 160 that are flexible. In various examples, portion 265 is continuous and/or contiguous with portion 264. In some embodiments, interface circuit 263 is configured to receive electrical signals from sensing mechanism 262 and transfer the data to transmitter 220. Portion 265 can be coupled to interface circuit 263 through an aperture 266 in casing 140 and an aperture 267 in structure 130.

In various embodiments, sensing mechanism 262 can be composed partially of a sensing fabric. For example, portions 264 and 265 can be made from the position sensor material described in U.S. Pat. No. 6,714,117 to David L. Sanback, which is incorporated herein by reference. In other embodiments, sensing mechanism 262 can be made from other flexible control mechanisms.

In the embodiment illustrated in FIGS. 1-3, outer surface 161 can include at least four buttons 139 that collectively form an X-shape. Buttons 139 are configured to allow the user to communicate to transmitter 220 what data to transmit to receiver 695 (FIG. 6). In the same or a different embodiment, buttons 139 can be controls for electrical device 690. In various examples, buttons 139 extend beyond the first surface of upper section 271, or the first plane. Configuring buttons 139 to have an X-shape provides tactile feedback to the user. In some examples, the raised X-shaped allows the user to find specific buttons with his hands, based on feel alone, even if the user is wearing gloves.

For example, buttons 139 can include (a) a button 141 in the center of the X-shape; (b) a button 142 located at a first arm of the X-shape; (b) a button 143 at a second arm of the X-shape; (c) a button 144 at a third arm of the X-shape; (d) a button 145 at a fourth arm of the X-shape. In some examples, the first and second arms are collinear with each other; and the third and forth arms are collinear with each other.

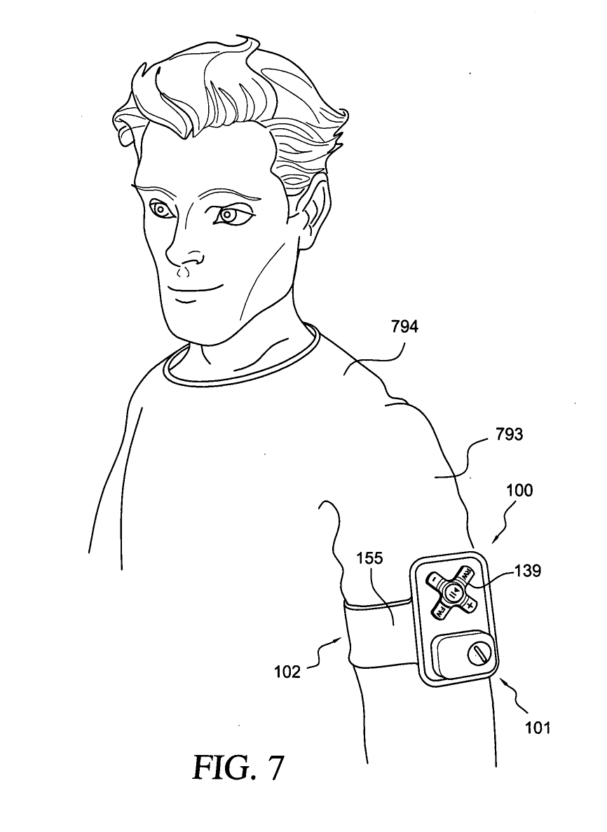

In the same or a different embodiment, an axis 146 can extend through buttons 141, 142, and 143; and an axis 147 can extend through buttons 141, 144, and 145. In this example, axis 146 can be perpendicular to axis 147 for form the X-shape. As illustrated in FIG. 7, however, axis 146 and axis 147 can be oriented such that they form a t-shape or “plus sign” when viewed by user while casing 140 and transmitter 220 are coupled to the upper arm of the user.

Each of buttons 139 can include markings or labels such that when casing 140 is coupled to the upper arm of the user, the labels are oriented to be readable right-side-up by the user. FIG. 7 illustrates a front, top, side isometric view of a communications device 100 coupled to an upper arm 793 of a user 794. FIG. 7 illustrates an example of an orientation of communications device 100 where the labels on buttons 139 are readable right-side-up by user 794 when communications device 100 is coupled to upper arm 793.

Referring again to FIGS. 1-2, these labels can indicate a function of buttons 139. For example, electrical device 690 (FIG. 6) can be a media player. In this example, buttons 142 and 143 can be for controlling volume. In one embodiment, buttons 142 and 143 could include the labels “−” and “+,” respectively, for decreasing and increasing, respectively, the volume. Likewise, buttons 144 and 145 can be for controlling a playing location. In one embodiment, buttons 144 and 154 can include the labels “RW” and “FW,” respectively, for moving backward or forward, respectively, within the track or to a different track. Button 141 can be for starting, pausing, and stopping electrical device 690 (FIG. 6). In one embodiment, button 141 can include the label “ [symbol] ∥.” Furthermore, user control mechanism 160 can be a tactile mechanism that provides a tactile sensation when user 794 (FIG. 7) presses any of buttons 141, 142, 143, 144, and 145.

Referring again to FIG. 3, coupling mechanism 350 can be configured to be coupled to a carabineer 352. In some examples, coupling mechanism 350 can be integrally formed or coupled to at least one of casing 140 and structure 130. In various embodiments, coupling mechanism 350 can be sewn, screwed, or attached with an adhesive to casing 140 and/or structure 130. For example, coupling mechanism 350 can be a loop, which can be sewn to casing 140. In this example, carabineer 352 can be attached through coupling mechanism 350, as shown in FIG. 3. In other examples, coupling mechanism 350 can be another type of attachment mechanism, such as a string tie, magnet, screw, adhesive, Velcro® material, or the like.

Referring again to FIGS. 4 and 5, coupling mechanism 451 is configured to be coupled to armband 155. In some examples, side 456 of bottom section 272 can be attached to or part of coupling mechanism 451. In this example, coupling mechanism 451 can be a large number of loops (e.g., Velcro® loops). Armband 155 can include a complementary coupling mechanism 554. In this example, coupling mechanism 554 is a large number of hooks (e.g., Velcro® hooks). In other embodiments, coupling mechanisms 451 and 554 can be string ties, magnets, screws, adhesives, or the like.

Armband 155 can be used to couple casing 140 and transmitter 220 to upper arm 793 (FIG. 7). Moreover, the labels on buttons 139 are oriented towards the user such that they are readable right-side-up by user 794 (FIG. 7) when coupling mechanism 451 is coupled to armband 155 and armband 155 is coupled to an upper arm 793 (FIG. 7).

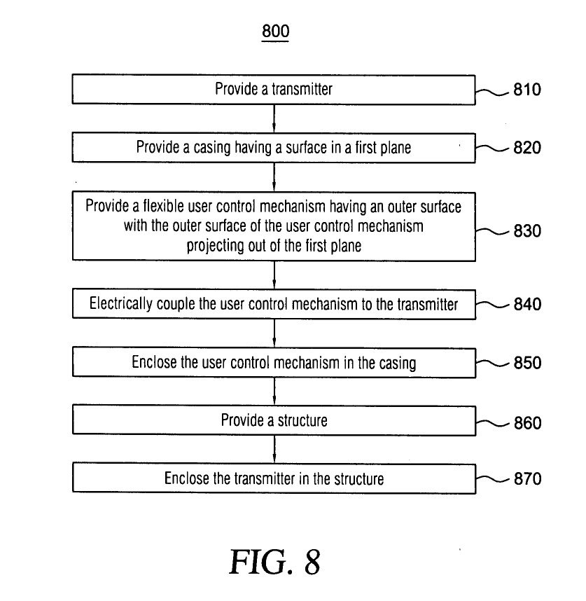

FIG. 8 illustrates a flow chart 800 for an embodiment of a method of manufacturing a communications device configured to remotely control an electrical device. Flow chart 800 in FIG. 8 includes a step 810 of providing a transmitter. As an example, the transmitter can be similar to transmitter 220 of FIG. 2.

Flow chart 800 in FIG. 8 continues with a step 820 of providing a casing having a surface in a first plane. As an example, the casing can have a surface in a first plane and can be similar to casing 140 with surface 129, as shown in FIG. 1.

In some embodiments, providing the casing in step 820 can provide the casing to include: (a) a first coupling mechanism configured to be coupled to a carabineer; and (b) a second coupling mechanism configured to be coupled to an armband. As an example, the first coupling mechanism can be similar to coupling mechanism 350 of FIG. 3. The second coupling mechanism can be similar to coupling mechanism 451 of FIG. 4.

Next, flow chart 800 in FIG. 8 includes a step 830 of providing a flexible user control mechanism having an outer surface with the outer surface of the user control mechanism projecting out of the first plane. As an example, the flexible user control mechanism can be similar to user control mechanism 160, as shown in FIG. 2.

In some embodiments, step 830 of providing the flexible user control mechanism can provide the flexible user control to include: (a) a first button located at a first arm of an X-shape; (b) a second button at a second arm of the X-shape; (c) a third button at a third arm of the X-shape; (d) a fourth button at a fourth arm of the X-shape; and (e) a fifth button at the center of the X-shape. As an example, the first, second third, fourth, and fifth buttons can be similar to buttons 142, 143, 144, 145, and 141, respectively, of FIG. 1.

Flow chart 800 in FIG. 8 continues with a step 840 of electrically coupling the user control mechanism to the transmitter. As an example, the user control mechanism being coupled to the transmitter can be similar to the coupling of user control mechanism 160 to transmitter 220, as described with reference to FIG. 2.

Subsequently, flow chart 800 in FIG. 8 includes a step 850 of enclosing the user control mechanism in the casing. As an example, the user control mechanism 160 enclosed in the casing can be similar to the enclosing of portions 264 and 265 in casing 140 as shown in FIG. 2.

Next, flow chart 800 in FIG. 8 includes a step 860 of providing a structure. As an example, the structure can be similar to structure 130, as shown in FIG. 2.

Flow chart 800 in FIG. 8 continues with a step 870 of enclosing the transmitter in the structure. As an example, the transmitter enclosed in the structure can be similar to the enclosure of transmitter 220 in structure 130, as shown in FIG. 1.

Although the invention has been described with reference to specific embodiments, it will be understood by those skilled in the art that various changes may be made without departing from the spirit or scope of the invention. For example, a portable power source strength indicator could be included on circuit board 225 and visible through structure 130 to indicate the remaining power of the portable power source. For example, an light emitting diode could change color when the power from the power source goes below a predefined level. In another example, steps 860 and 870 (FIG. 8) could occur before any of steps 830, 840, or 850 (FIG. 8). Additional examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. The case and method of use discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A communications device for remotely controlling an electrical device, the communications device comprising:
a transmitter for transmitting electrical signals;
a casing having a first surface in a first plane; and
a user control mechanism with an outer surface and electrically coupled to the transmitter, the outer surface of the user control mechanism projecting out of the first plane, wherein:
the casing and the transmitter are configured to be coupled to an upper arm of a user; and
the user control mechanism and the casing are flexible.

2. The communications device of claim 1, wherein:
the user control mechanism is a tactile mechanism.

3. The communications device of claim 1, wherein:
the casing includes the outer surface of the user control mechanism; and
the transmitter is devoid of being covered by the casing.

4. The communications device of claim 1, wherein:
the casing is configured to be coupled to a carabineer.

5. The communications device of claim 1, wherein:
the casing has an aperture; and
the transmitter is electrically coupled to the user control mechanism through the aperture.

6. The communications device of claim 1, further comprising:
an armband removably coupled to the casing and the transmitter,
wherein:
the armband is configured to couple the casing and the transmitter to the upper arm of the user.

7. The communications device of claim 1, wherein:
the user control mechanism comprises:
a center button;
two first buttons; and
two second buttons;
a first axis extends through the center button and the two first buttons;
a second axis extends through the center button and the two second buttons; and
the first axis is perpendicular to the second axis.

8. The communications device of claim 7, wherein:
each button of the center button, the two first buttons, and the two second buttons includes a label such that when the casing is coupled to the upper arm of the user, the label is oriented to be readable right-side-up by the user.

9. The communications device of claim 8, wherein:
the casing includes the outer surface of the user control mechanism; and
the transmitter is devoid of being covered by the casing.

10. The communications device of claim 9, further comprising:
a first coupling mechanism configured to be coupled to a carabineer; and
a second coupling mechanism configured to be coupled to an armiband.

11. The communications device of claim 7, further comprising:
the first axis and second axis has a plus-sign shape when viewed by the user while the casing and the transmitter are coupled to the upper arm of the user.

12. An electrical device for transmitting data to an electrical receiver, the electrical device comprising:
a cover having a first surface;
a transmitting module configured to broadcast the data;
at least four buttons extending beyond the first surface of the cover, electrically coupled to the transmitting module, and enclosed in the cover;
a first attachment mechanism configured to be coupled to a carabineer; and
a second attachment mechanism configured to be coupled to an armband, wherein:
the at least four buttons are configured to instruct the transmitting module to broadcast the data;
the at least four buttons collectively form an X-shape; and
the at least four buttons, the first attachment mechanism, the second attachment mechanism, and the cover are flexible.

13. The electrical device of claim 12, wherein:
the at least four buttons are controls for a media player coupled to the electrical receiver.

14. The electrical device of claim 12, further comprising:
an armband coupled to the second attachment mechanism, wherein:
each button of the at least four buttons has markings indicating a function of the button; and
the markings on the at least four buttons are oriented towards the user such that they are readable right-side-up by the user when the second attachment mechanism is coupled to the armband and the armband is coupled to an upper arm of a user.

15. The electrical device of claim 12, further comprising:
a structure for holding the transmitter module and a portable power source coupled to the transmitter module,
wherein:
the structure is devoid of being enclosed by the cover.

16. The electrical device of claim 12, wherein:
the at least four buttons comprise:
a first button located at a first arm of the X-shape for controlling volume;
a second button at a second arm of the X-shape for controlling volume;
a third button at a third arm of the X-shape for controlling a playing location;
a fourth button at a fourth arm of the X-shape for controlling a playing location; and
a fifth button at a center of the X-shape;
the first and second arms are collinear with each other; and
the third and forth arms are collinear with each other.

17. A method of manufacturing a communications device configured to remotely control an electrical device, the method comprising:
providing a transmitter;
providing a casing having a surface in a first plane;
providing a flexible user control mechanism with an outer surface, the outer surface of the user control mechanism projects out of the first plane;
electrically coupling the user control mechanism to the transmitter; and
enclosing the user control mechanism in the casing.

18. The method of manufacturing of claim 17, further comprising:
providing a structure;
enclosing the transmitter in the structure; and
keeping the structure outside of the casing.

19. The method of manufacturing of claim 17, further comprising:
providing the casing to further comprise:
a first coupling mechanism configured to couple to a carabineer; and
a second coupling mechanism configured to couple to an armband.

20. The method of manufacturing of claim 17, wherein:
providing the flexible user control mechanism to further comprise:
a first button located at a first arm of an X-shape;
a second button at a second arm of the X-shape;
a third button at a third arm of the X-shape;
a fourth button at a fourth arm of the X-shape; and
a fifth button at a center of the X-shape.
